(19) United States
(12) Patent Application Publication
(10) Pub. No.: US 2002/0106923 A1
(43) Pub. Date: Aug. 8, 2002

(54) Device for producing an electrically conductive pipe joint

(76) Inventors: Daniel A. Copeland, Bessemer, AL (US); Glenn A. Thomas, Birmingham, AL (US)

Correspondence Address: BRADLEY ARANT ROSE & WHITE, LLP, 2001 PARK PLACE, SUITE 1400, BIRMINGHAM, AL, 352032736

(21) Appl. No.: 09/775,890

(22) Filed: Feb. 2, 2001

(51) Int. Cl. H01R 4/60

(52) U.S. Cl. 439/192

(57) ABSTRACT

Disclosed is an electrically conductive body which can be attached to a non-conductive sealing element in a pipe joint to render the resulting pipe joint electrically conductive. The electrically conductive body may be a clip of generally a C shape made of or incorporating an electrically conducting material, such as copper, that is attachable to the sealing element. However, the electrically conductive device may take other forms depending on the configuration of the sealing element and the pipe joint.

### BACKGROUND

1. Field of Invention

This disclosure relates to pipe joints for connecting ductile iron or other metallic pipe which incorporate non-conducting sealing elements. In particular, to an electrically conductive body which can be attached to a non-conductive sealing element in a pipe joint to render the resulting pipe joint electrically conductive.

2. Related Art

In the construction of pipe lines, it is necessary to connect many segments of pipe together through the use of pipe joints to form the finished pipe line. A pipe joint typically consists of the ends of the pipes to be joined and a sealing element to effect a seal between the joined pipes. By necessity, the pipe joints are constructed in the field as the pipe is laid down.

A common type of pipe joint is referred to as a push-on or slip joint. In constructing this type of pipe joint, the outer pipe, sometimes referred to as the bell, typically has an end of greater diameter than the inner pipe, sometimes referred to as the spigot. The inner pipe end is forced into the outer pipe end and the resulting joint is sealed by a sealing element, typically a gasket. The gasket material is commonly an electrical insulator, which renders the completed pipe joint incapable of conducting an electrical current.

The non-conducting characteristic of the gasket presents a problem in climates where freezing conditions are encountered. In such conditions, it is not uncommon for the liquid in some pipe line sections to freeze. As a result, the flow of liquid in these pipes becomes blocked. In such cases, it is necessary to thaw the pipe line to return it to service. Although it is not common for sections of pipe in the service main to freeze and become blocked due to the diameter of the pipe in the service main, it is common for sections of smaller diameter pipes that run from the service main (sometimes referred to as feeder lines) to freeze. The common method to thaw the pipe sections is to pass an electrical current through the pipe, thereby heating the pipe sections via the effects of electrical resistance. To pass an electrical current through the pipe, it is essential that a closed electrical circuit exist in the both the service main and the feeder lines. Therefore, when pipe joints are employed that use a sealing element which is an electrical insulator, an additional device must be employed at each pipe joint to complete the closed electrical circuit. Several such devices have been used to date.

One of the earliest solutions was to drive a wedge, made of metal or other conducting material, between the two pipe sections to create a closed circuit. However, this method was unsatisfactory because the inserted material often became dislodged from the pipe joint, interrupting the electrical circuit. Further, this method could also interfere with the integrity of the pipe joint seal. An additional method of providing electrical conductivity over a pipe joint was to connect the two section of pipe with metal strips. In this method, conducting strips (of copper or other metallic material) are welded to each pipe section. After the pipe sections are assembled, the conducting strips are connected by a jumper strip, thereby providing a closed electrical circuit. This method is unsatisfactory due to the additional cost of manufacturing the pipe sections in conjunction with the welded conducting strips. Further, this method required extensive efforts from the workers laying the pipe in the field, increasing the cost of installing the pipe. Additionally, the welds have a tendency to break over time with resulting loss of electrical conductivity.

U.S. Pat. No. 2,991,092 to MacKay discloses a pipe joint that is capable of conducting an electrical current. MacKay teaches the insertion of a ring of conducting material into the pipe joint, which is capable of contacting both sections of pipe in the joint. The pipe joint disclosed by MacKay also suffers from several disadvantages. First, the conducting material must be inserted into the pipe first, followed by the gasket. Second, the conducting ring must be bent out of its original shape in order to attain its proper orientation in the pipe joint and provide electrical conductivity. These steps make assembly of the pipe more time consuming in the field and raise the possibility the conducting ring might not assume its proper orientation in the pipe joint. Third, the conducting ring is in direct contact with a portion of the gasket that performs the sealing function. As a result, if the conducting ring heats up while conducting electrical current, the integrity of the gasket may be compromised due to gasket melting caused by the conducting ring, leading to failure of the pipe joint.

U.S. Pat. No. 3,244,797 to Watson discloses a pipe joint that incorporates a conducting material into a cavity formed between the outer and inner pipes of the pipe joint. The pipe joint of Watson likewise has several disadvantages. First, the conducting material is hammered into place after the pipe joint is constructed. This process is time consuming, which increases the cost of the finished pipe line. Second, the conducting material is held in place in the cavity only by the force of friction, raising the possibility that the conducting material may become dislodged over time leading to loss of electrical conductivity.

U.S. Pat. No. 3,249,685 to Heflin discloses a pipe joint formed between two pipe ends of the same diameter by using a clamping ring and a gasket. The pipe joint may be made electrically conductive by manufacturing the gasket to include an electrically conductive portion which contacts both ends of the pipe. The pipe joint of Heflin suffers from the drawback that it is expensive to manufacture, since the gasket must be manufactured in multiple steps to incorporate the electrically conductive portion. The method of Heflin also requires pipe sections of non-standard manufacture.

Another solution has been to incorporate conductive elements into the material of the gasket itself. In such a solution, the conductive material is built into the gasket and the gasket is produced in such a way that the conductive material will be exposed on the outer and inner sides of the gasket. In this manner the conductive material contacts both the outer and inner pipes creating a closed electrical circuit. This method suffers from several drawbacks. First, the gasket must be manufactured in multiple steps, thereby greatly increasing the cost of the gasket. Second, the conducting element is in contact with the sealing portion of the gasket, increasing the chance that the operation of the conducting element may compromise the integrity of the gasket as discussed above.

### SUMMARY

The present invention is directed to a device that allows a pipe joint incorporating a non-conductive sealing element to be made electrically conductive. The device comprises an electrically conductive body that can be attached to the sealing element of a pipe joint and at the same time contact both the outer and inner pipes, thereby creating a closed electrical circuit. The electrically conductive body of the present invention is simple to manufacture and can be used with multiple pipe joint configurations.

It is, therefore, a primary object of the invention is to provide an electrically conductive body that can be attached to a sealing element, thereby converting the non-conducting sealing element into a sealing element capable of conducting electricity between connected pipe segments.

Another object of the invention is to provide an electrically conductive pipe joint, which employs a non-conductive sealing element to which is attached one or more electrically conductive bodies to the sealing element. The electrically conductive pipe joint of the invention can be quickly assembled in the field and will remain sealed when subject to high internal fluid pressure.

A further object of the invention is to provide an electrically conductive pipe joint in which the amount of electrical current flowing through the pipe can be easily adjusted by varying the number of electrically conductive bodies attached to the sealing element.

A further object of the invention is to provide a pipe joint in which the electrically conducting body that allows for conducting electrical current is not in direct contact with the portion of the sealing element that provides the integrity of the pipe joint.

A further object of the invention is to provide a method for creating an electrically conductive pipe joint, the pipe joint incorporating a non-conductive sealing element and one or more electrically conductive bodies.

These and other features, aspects and advantages of the invention will become better understood with regard to the following description, appended claims and drawings.

### BRIEF DESCRIPTION OF THE DRAWINGS

FIG. 1 is a cross-sectional side view of a clip, an embodiment of the electrically conductive body, which is attachable to the sealing element in a pipe joint;

FIG. 2 is a cross-sectional side view of the clip of FIG. 1, showing the relationship of the clip to the sealing element, in this embodiment, an insulating rubber gasket;

FIG. 3 is a perspective view showing the placement of the clip of FIG. 1 on a sealing element, in this embodiment, an insulating rubber gasket;

FIG. 3A is a perspective view of the clip of FIG. 1;

FIG. 4 is a sectional view down the longitudinal axis of a pipe joint incorporating the clip and sealing element of FIGS. 2 and 3, showing the components prior to assembly of the pipe joint;

FIG. 5 is a sectional view down the longitudinal axis of a pipe joint incorporating the clip and sealing element of FIGS. 2 and 3, showing the components after the assembly of the pipe joint;

FIG. 6 is a perspective view illustrating the relationship between the inner pipe end, sealing element, in this embodiment an insulating rubber gasket, clip and outer pipe end; and

FIGS. 7a and 7b are perspective views illustrating the assembly of one embodiment of an electrically conducting pipe joint according to the specification.

### DESCRIPTION

The disclosure relates to an electrically conducting body that allows a pipe joint incorporating a non-conductive sealing element, and therefore incapable of conducting electrical current, to be made electrically conductive. The body can be attached to the sealing element of a pipe joint in a manner so that the body will simultaneously make contact with both the outer and inner pipe ends, thereby creating a closed electrical circuit. The word attach, attached or attachable should be construed in this specification as encompassing any manner in which the electrically conducting body may be retained on the sealing element, such as by pinch pressure friction (as described below), by being partially integrated into the sealing element, or by using adhesives to secure the body to the sealing element.

In an embodiment, the electrically conducting body is an electrically conducting clip of generally a C shape that is adapted to be attached to the sealing element. In this embodiment, the clip comprises an upper arm, a vertical base and a lower arm. The clip may further comprise a lip extending downwardly from the end of the upper arm opposite the vertical base. The clip is composed of or incorporates a conducting material, for example copper. The sealing element can be any device that creates a liquid impermeable seal, such as a gasket. The gasket can be composed of any suitable material, but a common material is rubber. The clip is retained on the sealing element by the pressure exerted by the upper and lower arms, the vertical base and lip (if present) of the clip on the sealing element. As the sealing element is commonly an insulating gasket composed of incorporating rubber, the sealing element will be compressed slightly by the clip and exert pressure against the clip. As the result of this pressure the clip is retained on the sealing element. In the specification and claims, this is referred to as pinch pressure friction. Application of the clip to the gasket is quick and efficient and allows for easy application in the field. Further, the clip can be removed from the gasket if the need arises. Despite the ease of assembly of the clip to the gasket, the clip is held securely in place on the gasket by the pinch pressure friction. It should be noted that the various angles formed by the component parts of the clip, and the lengths of the component parts of the clip can be varied in order to generate the required pinch pressure friction needed to retain the clip to various sealing elements without departing from the teachings of the instant disclosure.

The clip and gasket combination is placed in a receiving cavity in the outer pipe. In this placement, the clip is in contact with the outer pipe. The inner pipe is then placed inside the outer pipe to create a pipe joint. The inner pipe contacts the lower arm of the clip. As a result of the contacts with both the outer and inner pipe ends, the clip forms a closed circuit across the completed pipe joint. In the completed pipe joint, the gasket and clip combination is secured between the outer and inner pipe and will not slip out of place when the pipe joint expands, contracts or deflects.

The following figures described one embodiment of the electrically conducting body, namely, where the electrically conducting body is a clip of generally a C-shape. The dimensions and angularities of the clip in this particular embodiment have been adapted for use with a gasket (as the sealing element) that is commonly used in the industry and are for illustrative purposes only. This particular embodiment is not meant to restrict the teachings of the instant specification to this embodiment, and it should be understood various changes, modifications and substitutions may be incorporated without departing from the teachings of the instant disclosure.

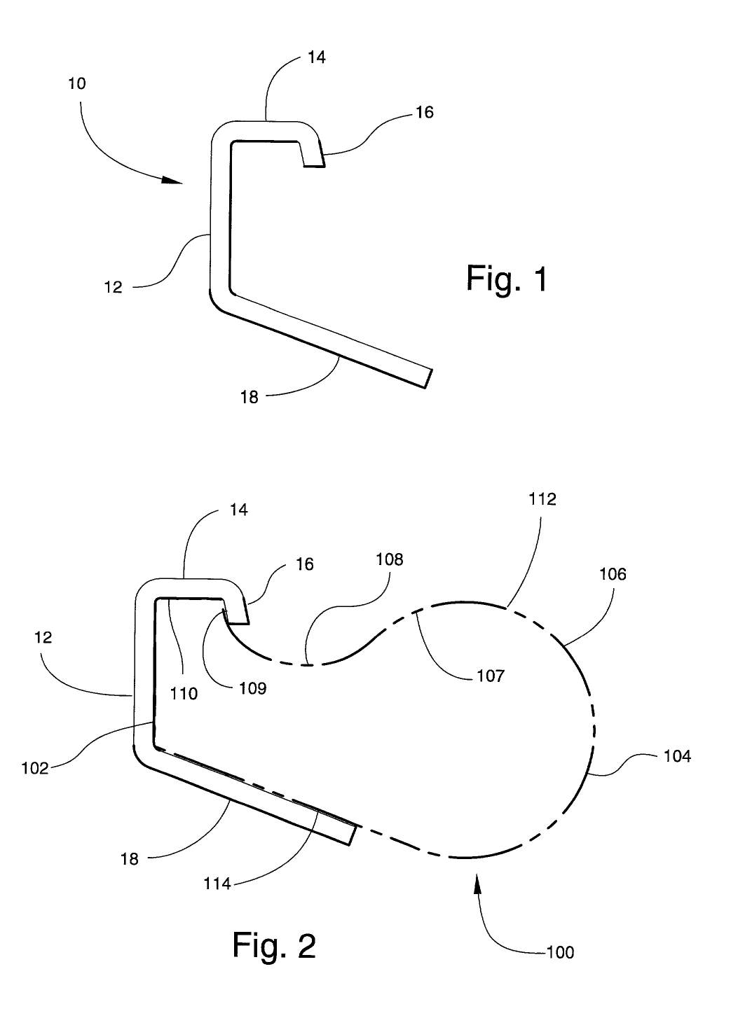

As illustrated in FIG. 1, an embodiment of the device is a clip 10 of generally a C shape comprising a vertical base 12, an upper arm 14, a lip 16 and a lower arm 18. The upper arm 14 extends forwardly from the top of vertical base 12. The lip 16 extends downwardly from the end of the upper arm 14 opposite the vertical base 12. The lower arm 18 extends from the bottom of the vertical base downwardly and forwardly. The dimensions and angularities of the clip 10 are adapted to fit the contours of the particular sealing element used. In this embodiment of the clip 10, which is adapted to fit an insulating rubber gasket commonly used in the art, the upper arm 14 forms an approximate 90 degree angle with the top of the vertical base 12, the lip 16 forms and angle in the range of 75 to 135 degrees, preferably 102 degrees, with the upper arm 14, and the lower arm 18 forms an angle in the range of 90 to 135 degrees, preferably 120 degrees, with the vertical base 12.

FIG. 2 illustrates the clip 10 in conjunction with a sealing element, which in this embodiment is an insulating rubber gasket 100 as is commonly used in the art. The clip 10 is attached to the gasket 100. The gasket 100 comprises a rear gasket wall 102, a front gasket wall 104, an outer side wall 112 and an inner side wall 114. The outer side wall 112 comprises a sealing portion 106, a channel portion 108, and a ridge portion 110. The sealing portion 106 is contiguous with the front gasket wall 104 and the first channel shoulder 107. The channel portion 108 is defined by and contiguous with the first channel shoulder 107 and the second channel shoulder 109. The ridge portion 110 is contiguous with the second channel shoulder 109 and the rear gasket wall 102. The inner side wall 114 is contiguous with the rear gasket wall 102 and the front gasket wall 104, and slopes downwardly from the rear gasket wall toward the front gasket wall 104.

The clip 10 is adapted generally to conform to the contours of the rear gasket wall 102, the outer side wall 112 and the inner side wall 114. The ridge portion 110 occupies a cavity created in clip 10 by the vertical base 12, the upper arm 14, the lip 16 and the lower arm 18. In the cavity, the ridge portion 110 contacts the underside of upper arm 14, the second channel shoulder 109 contacts the underside of the upper the lip 16, the rear gasket wall 102 contacts the inside of the vertical base 12 and the inner side wall 114 contacts the inside of lower arm 18. The clip 10 is secured to the gasket 100 by these contacts and the resulting pinch pressure friction they create. As stated above the dimensions and angularities of the clip 10 are adapted to fit the contours of the particular sealing element used.

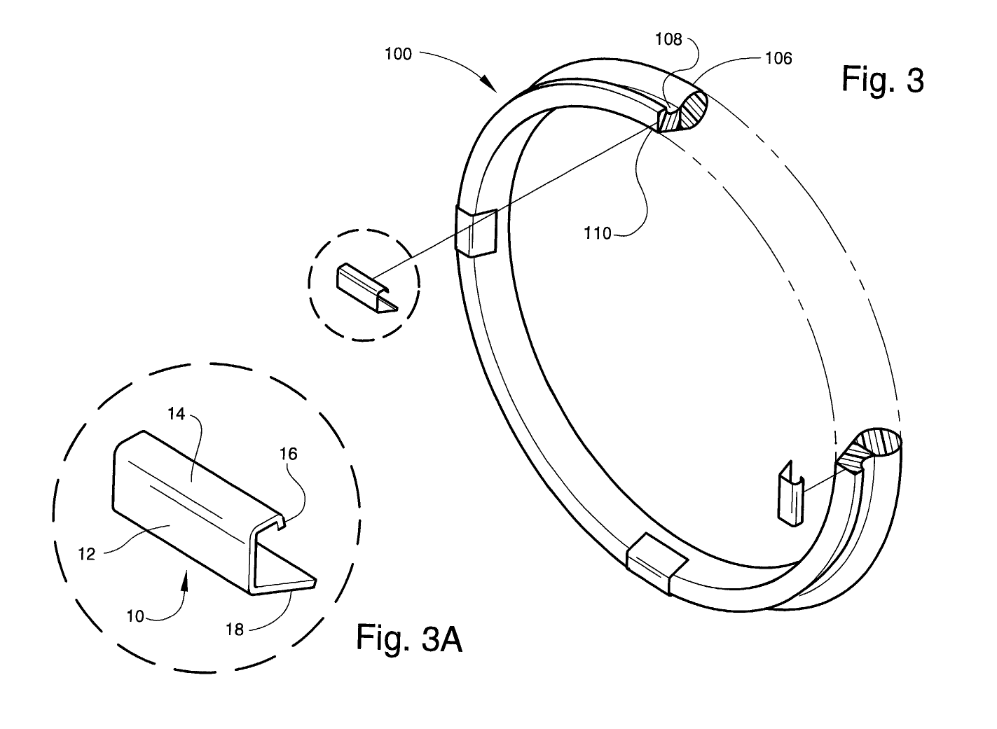

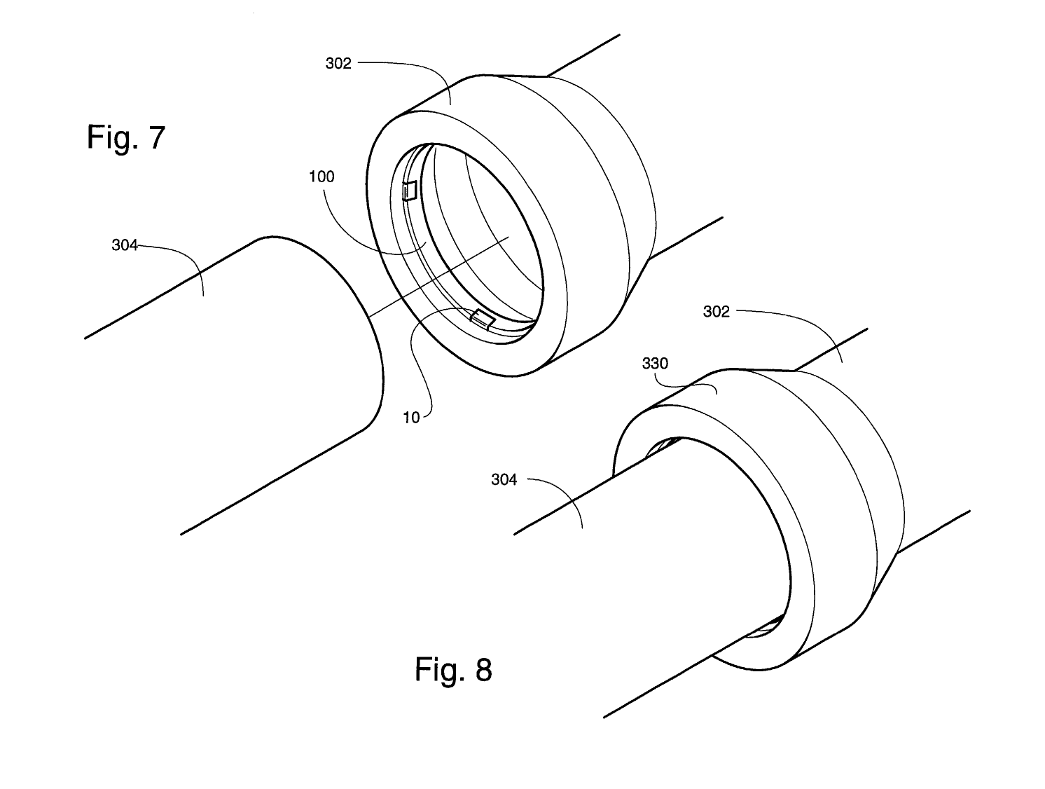

FIG. 3 is a perspective view illustrating the placement of the clip 10 on the sealing element, in this case an insulating gasket 100, while FIG. 3A is a perspective view of the clip 10. The clip 10 engages the gasket 100 as illustrated in FIG. 2 and described above. The number of clips 10 that are placed on the gasket 100 can be varied by the user. Placing additional clips 10 on the gasket 100 will allow for increased current flow across the pipe joint 330 (described in FIG. 7A). The placement of four clips 10 on the gasket 100 is for illustrative purposes only, and is not meant to limit the number of clips 10 that can be placed on gasket 100.

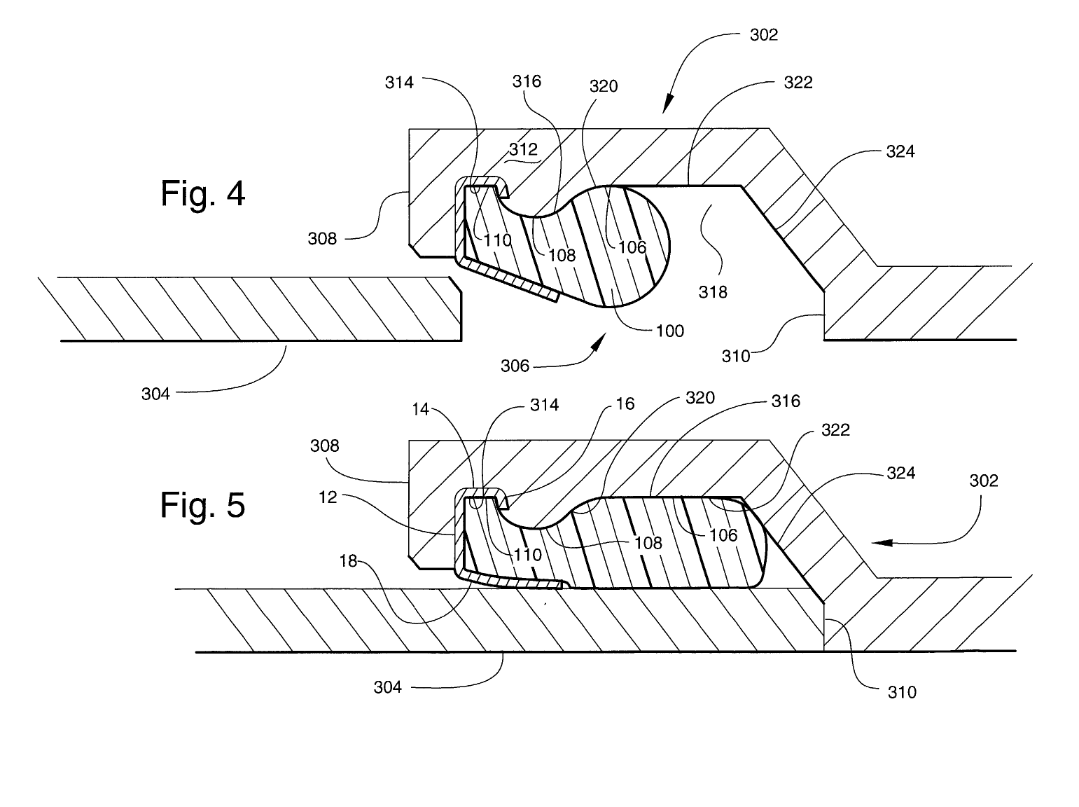

FIG. 4 illustrates the clip and sealing element of FIGS. 2 and 3 in an unassembled pipe joint. The pipe joint 300 comprises an outer pipe 302 and an inner pipe 304, the ends of which are adapted to telescope together to form the pipe joint. The outer pipe 302 is adapted to receive a sealing element, in this embodiment a gasket 100. The outer pipe 302 has a greater diameter than the inner pipe 304 and contains an annular cavity 306 for receiving the gasket 100 in combination with the clip 10. The annular cavity 306 comprises and is defined by an front end wall 308, a back end wall 310 and aside wall 312. The front end wall 308 and the back end wall 310 are substantially perpendicular to the horizontal axis of the outer pipe 302, while the side wall is of irregular configuration. The side wall further comprises a first annular recess 314, a shoulder 316 and a second annular recess 318. The first annular recess 314 is defined by the front end wall 308 and the shoulder 316. The radial circumference of the first annular recess 314 is greater than the radial circumference of the shoulder 316. The second annular recess 318 is located behind the shoulder 316 and is defined by the shoulder 316 and the back end wall 310. The second annular recess comprises a first sloped portion 320 extending in an axially divergent manner from the rear edge of the shoulder 316 and a flat portion 322 extending from the rear edge of the first sloped portion 320 to the front edge of the second sloped portion 324, and a second sloped portion 324 extending in an axially divergent manner from the back edge of the flat portion 322 to the front edge of the back end wall 310. The radial circumference of the second annular cavity 318 is initially greater than the radial circumference of the shoulder 316, but as the second annular cavity 318 approaches the back end wall 310, the radial circumference becomes less than the radial circumference of the shoulder 316.

The ridge portion 110 of the gasket 100 and the vertical base 12, the upper arm 14 and the lip 16 of the clip 10 fit securely in the first annular recess 314. The channel portion 108 fits securely under the shoulder 316 and the sealing portion 106 extends into the second annular cavity 318. In this configuration, the vertical base 12, the upper arm 14 and the lip 16 of clip 10 are in contact with the outer pipe 302. Specifically, the upper arm 14 and the lip 16 are in contact with the first annular recess 314 and the vertical base 12 is in contact with the front end wall 308.

FIG. 5 illustrates the clip and sealing element of FIGS. 2 and 3 in an assembled pipe joint. The inner pipe 304 is placed inside the outer pipe 302 so that the inner pipe 304 closely approaches or touches the back end wall 310. In this manner the gasket 100 is deformed and the sealing portion 106 fills a portion of the second annular cavity 318. The ridge portion 110 and the clip 10 remain securely fitted in the first annular recess 314. In this configuration, the clip 10 is attached to the gasket 100 and is in contact with both the outer pipe 302 and the inner pipe 304, and the clip and gasket combination are secured in the completed pipe joint. Specifically, the upper arm 14 and the lip 16 are in contact with the first annular recess 314, the vertical base 12 is in contact with the front end wall 308 and the lower arm 18 is in contact with the inner pipe 304. Through these contacts a closed electrical circuit is formned.

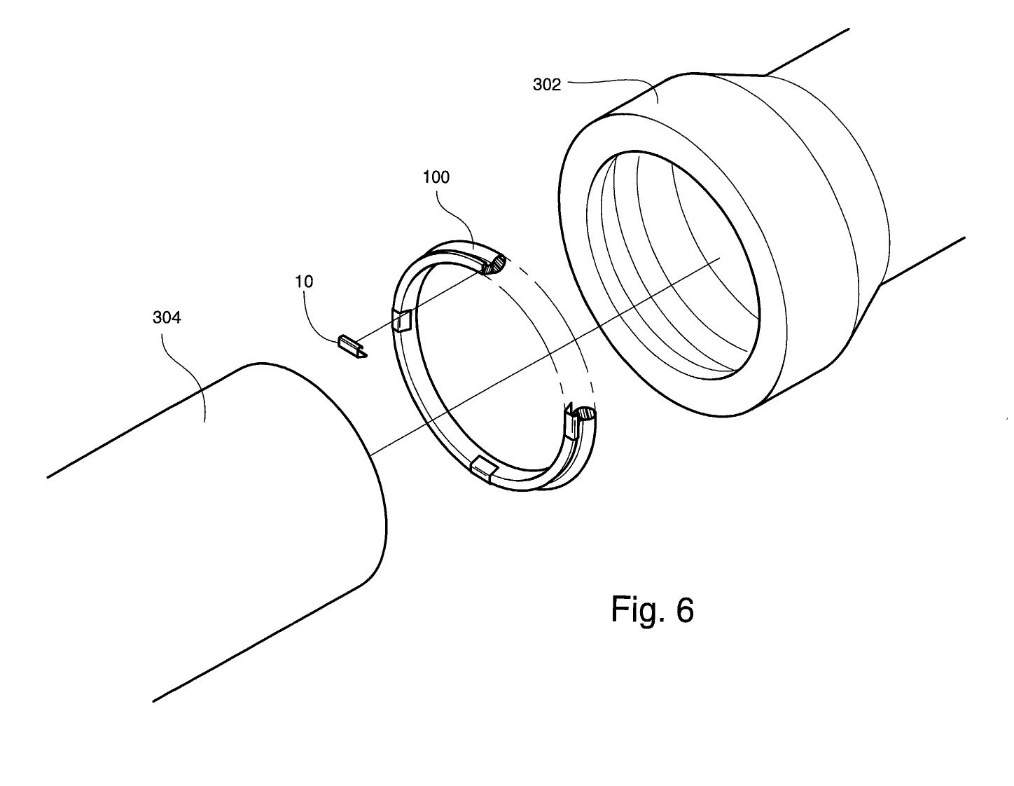

FIG. 6 shows a perspective view illustrating the relationship between the inner pipe end 304, sealing element, in this embodiment, an insulating rubber gasket 100, clip 10 and outer pipe end 302. FIG. 7 illustrates the placement of the clip 10/gasket 100 combination incorporated into the annular cavity 306 of outer pipe end 302. As illustrated in FIG. 7A and as described above, the inner pipe end 304 is then inserted into the outer pipe end 302 in order to create a sealed pipe joint. By the placement of clip 10 on gasket 100 electrical current is allowed to pass through the completed pipe joint 330.

The previously described embodiments of the present invention have many advantages. For simplicity, the discussion below will refer to the embodiment illustrated in the drawings and described above, namely a clip of generally a C shape, and a insulating gasket. The clip is attached to the gasket by pinch pressure friction, decreasing the risk that the clip will become dislodged from the gasket when the gasket is inserted into the outer pipe. Further, the clip fits over a portion of the gasket (the ridge portion) that is not responsible for the sealing integrity of the gasket. This placement give the advantage that if the clip becomes overheated due to prolonged exposure to electrical current, any heat will be dissipated into portions of the gasket that are not responsible for the sealing function and will not melt portions of the gasket responsible for gasket integrity. Prior attempts to provide a closed electrical circuit over pipe joints placed the conductive element in direct contact with areas of the gasket responsible for maintaining seal integrity, meaning that if the conductive element overheated, the transferred heat could cause gasket melting and breach the seal integrity.

Importantly, the clip is simple to incorporate into the finished pipe joint. The clip is simply snapped by hand onto the gasket and the gasket is used in its normal manner to form the finished, electrically conductive pipe joint. Previous attempts to form an electrically conductive pipe joint required significant additional steps, such as modification to the pipe segments, hammering the conductive element into the pipe joint, or separately placing the conductive element into the pipe joint. Therefore, the present invention decreases the manpower and time needed to construct the pipe joint, decreasing the overall cost of the finished pipe installation. Additionally, the clip is simple to manufacture. The clip can be rapidly formed from a single piece of conducting material, such as copper. Previous attempts required the manufacture of a non-standard, special gasket that incorporated electrically conductive elements into the gasket itself, or specially manufactured pipes. Such alternatives required additional manufacturing steps, significantly increasing the cost of producing the completed pipe joints.

The present invention also provides a simple and cost effective means to adjust the amount of current flow across the pipe joint. By simply adding additional clips to the gasket, the current flow across the pipe joint can be increased. Conversely, by decreasing the number of clips, the current flow across the pipe joint can be decreased. Previous methods using conducting rings and similar articles could be made to vary the current flow, but required either the manufacture of alternate forms of the rings or the time consuming process of modifying the rings to accommodate increased or decreased current.

Finally, the clip is automatically set in its proper orientation once it is attached to the gasket. Under normal conditions of use, the clip will remain in the proper orientation as a result of the pinch pressure friction. The sealing element is then incorporated into the pipe joint without any special steps or processes. These advantages are merely illustrative and are not intended to be a comprehensive listing of all the advantages inherent in the present invention.

Although the present invention has been described in considerable detail with reference to certain embodiments thereof, other variations are possible. Therefore, the scope of the appended claims should not be limited to the description of the preferred embodiments contained herein.

What is claimed is:

1. An electrically conducting body to create electrical conductivity in a pipe joint incorporating 2 pipe ends and an insulating sealing element, the body being adapted to be attachable to a sealing element in the pipe joint and configured to make contact with both pipe ends of the pipe joint.

2. The device of claim 1, where the electrically conductive body is a clip.

3. The device of claim 2, where the clip has a generally C shape and comprises a vertical base, an upper arm extending forwardly from the top of the vertical base, and a lower arm extending forwardly from the bottom of the vertical base.

4. The clip of claim 4 where the upper arm further comprises a downwardly turning lip at the end thereof opposite the vertical base.

5. The clip of claim 4 where the upper arm are extends substantially perpendicularly from the vertical base, the lower arm forms an angle in the range of 90 to 135 degrees with the vertical base and the lip forms an angle in the range of 75 to 135 degrees with the upper arm.

6. The device of claim 4 where the sealing element is an insulating gasket.

7. A pipe joint for joining two electrically conductive pipe ends together, the pipe joint comprising two pipe ends adapted to be joined together to form a pipe joint, a sealing element interposed in the pipe joint, and an electrically conductive body adapted to be attachable to the sealing element in the pipe joint, the body maintaining contact with both the outer and inner pipe ends.

8. The pipe joint of claim 7 where the electrically conductive body is a clip.

9. The pipe joint of claim 8 where the clip has a generally C shape and comprises a vertical base, an upper arm extending forwardly from the top of the vertical base, and a lower arm extending forwardly from the bottom of the vertical base.

10. The pipe joint of claim 9 where the upper arm further comprises a downwardly turning lip at the end thereof opposite the vertical base.

11. The pipe joint of claim 10 where the clip is retained on the sealing element by pinch pressure friction.

12. The pipe joint of claim 10 where the upper arm are extends substantially perpendicularly from the vertical base, the lower arm forms an angle in the range of 90 to 135 degrees with the vertical base and the lip forms an angle in the range of 75 to 135 degrees with the upper arm.

13. The pipe joint of claim 10 where the sealing element is an insulating gasket.

14. A method for creating an electrically conductive connection between two pipe ends adapted to be joined together to form a pipe joint comprising attaching at least one electrically conductive body to a sealing element and inserting the sealing element with at least one attached body in the pipe joint so that the body is in contact with both pipe ends.

15. The method of claim 14 where the electrically conductive body is a clip.

16. The method of claim 15 where the clip has a generally C shape and comprises a vertical base, an upper arm extending forwardly from the top of the vertical base, and a lower arm extending forwardly from the bottom of the vertical base.

17. The method of claim 16 where the upper arm further comprises a downwardly turning lip at the end thereof opposite the vertical base.

18. The method of claim 17 where the clip is retained on the sealing element by pinch pressure friction.

19. The method of claim 17 where the upper arm are extends substantially perpendicularly from the vertical base, the lower arm forms an angle in the range of 90 to 135 degrees with the vertical base and the lip forms an angle in the range of 75 to 135 degrees with the upper arm.

20. The method of claim 17 where the sealing element is an insulating gasket.
